(19) United States
(12) Patent Application Publication
(10) Pub. No.: US 2013/0104929 A1
(43) Pub. Date: May 2, 2013

(54) PORTABLE BOILER/SCR ONLINE PINPOINT PULSE DETONATION CLEANING DEVICE

(71) Applicants: Tian Xuan Zhang, Overland Park, KS (US); Peter Martin Maly, Lake Forest, CA (US); David M. Chapin, Cincinnati, OH (US)

(72) Inventors: Tian Xuan Zhang, Overland Park, KS (US); Peter Martin Maly, Lake Forest, CA (US); David M. Chapin, Cincinnati, OH (US)

(73) Assignee: BHA Group, Inc., Kansas city, MO (US)

(21) Appl. No.: 13/281,781

(22) Filed: Oct. 26, 2011

(51) Int. Cl. B08B 9/032; B08B 5/00; B08B 7/02

(52) U.S. Cl. 134/1; 134/168 R; 15/339; 15/406

(57) ABSTRACT

A pulse detonation system is provided for delivering a shock wave to an operating device to clean accumulation or buildup of particles within the operating device. The pulse detonation system includes a support structure, a camera apparatus and a pulse detonation chamber. The pulse detonation chamber is supported by the support structure and extends into the interior portion of the operating device. The pulse detonation chamber receives fuel and air to create a shock wave. The shock wave exits the pulse detonation chamber and interacts with the buildup of particles in the operating device. The pulse detonation chamber includes a plurality of pulse detonation tubes that are detachable and portable, such that the pulse detonation system can be detached and moved from a first location to a second location.

### BACKGROUND OF THE INVENTION

1. Field of the Invention

The invention relates to a cleaning device for removing particle buildup and, more particularly, to a portable pulse detonation cleaning device that delivers a shock wave to an operating device to agitate particle buildup within the operating device.

2. Discussion of Prior Art

High-temperature operating devices may include baghouses, heat exchangers, boilers, selective catalytic reduction (SCR) devices, etc. Particles including, but not limited to, dirt, dust, ash, slag, or the like, may accumulate on walls and/or structures, such as heat exchanger tubes, within the operating device. It can be difficult to remove particles that have accumulated on walls and/or structures within the operating device and may require taking the operating device out of service to clean it. Furthermore, even with regular cleaning procedures, such as steam soot blowers and the like, the operating device may occasionally have to be shut down for further cleaning.

Pulse detonation devices have been used to emit a shock wave in a variety of different applications. Delivering shock waves from the pulse detonation device into the operating devices can agitate the particles or structures, thus dislodging the particles from the surfaces of the operating device. However, the shock waves are limited in the distance from the exit of the pulse detonation device that they can effectively clean within the operating device. Accordingly, it would be useful to provide a pulse detonation cleaning device that can provide a shock wave to a targeted area of particle buildup within the operating device without shutting down the operating device. It would also be useful for the pulse detonation cleaning device to be portable and/or movable, such that the device can be readily transported and used at different locations or to focus the cleaning force at desired locations.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a pulse detonation system for providing a cleaning shock wave to an interior surface of an operating device, the pulse detonation system comprising a pulse detonation chamber configured to provide one or more shock waves into the operating device, wherein the pulse detonation chamber includes at least one pulse detonation tube, wherein the pulse detonation chamber is configured to be movable with respect to the operating device, further wherein an outlet end of the pulse detonation chamber is configured to be oriented towards a plurality of locations within the operating device.

In accordance with another aspect, the present invention provides a portable pulse detonation system for providing a shock wave to an operating device, the portable pulse detonation system comprising a camera apparatus configured to capture and display images of an interior portion of the operating device, and a pulse detonation chamber extending from an exterior to the interior portion of the operating device, the pulse detonation chamber configured to provide one or more shock waves to the interior portion of the operating device, wherein the pulse detonation chamber includes at least one pulse detonation tube removably attached to a second pulse detonation tube.

In accordance with another aspect, the present invention provides a method of cleaning an operating device. The method includes displaying images of an interior portion of the operating device with a camera apparatus, positioning a pulse detonation chamber to extend from the exterior to the interior portion of the operating device, orienting the pulse detonation chamber towards a target area based on the images of from the camera apparatus, and igniting a mixture of fuel and air in the pulse detonation chamber to create a shock wave, wherein the shock wave exits the pulse detonation chamber and engages the target area of the operating device.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic side view, partially torn open, of an example operating device with an example pulse detonation device shown;

FIG. 2 is a sectional side view of the example operating device of FIG. 1 with the example pulse detonation device shown; and

FIG. 3 is a sectional side view of the example operating device with a second example pulse detonation device shown.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

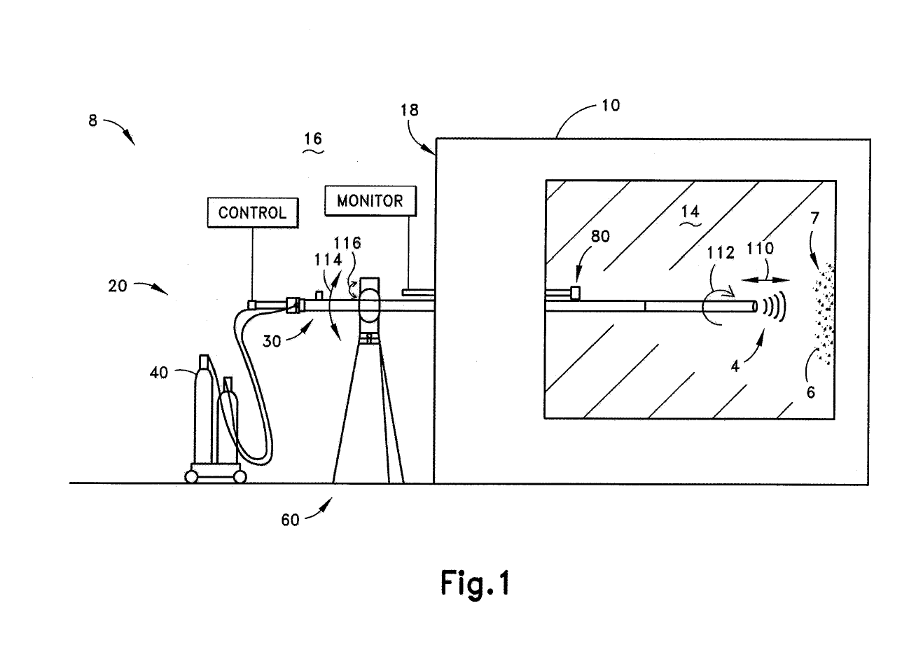

FIG. 1 illustrates a pulse detonation system 8 for providing a shock wave 4 to a structure of an operating device 10. The pulse detonation system 8 can include a pulse detonation device 20 in association with the operating device 10. The shock wave 4 can be formed in the pulse detonation device 20 and can be directed toward a buildup of particles 6 within the operating device 10. A camera apparatus can be provided to capture and display images of an interior portion 14 of the operating device 10. The pulse detonation device 20 can be moved and adjusted based on the images from the camera apparatus. Furthermore, the pulse detonation device 20 can be assembled and disassembled, such that the pulse detonation device 20 can be readily portable and usable on a variety of different operating devices.

It is to be appreciated that the operating device 10 is only generally/schematically shown in the figures, and may be varied in construction and function. For instance, the operating device 10 may include a variety of devices including, but not limited to, boilers, portable boilers, heat exchangers, selective catalyst reduction devices (SCR), electrostatic precipitator (ESP), baghouses, cooling towers, spray towers, fans, etc. As such, the operating device 10 shown and described herein need not be a specific limitation upon the present invention.

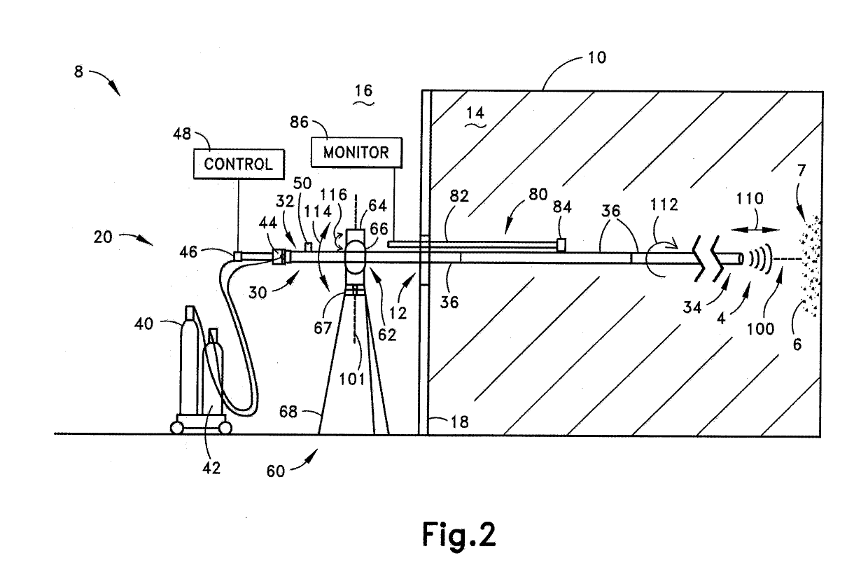

Referring still to FIG. 1, the operating device 10 can include the interior portion 14. The interior portion 14 can include a variety of structures, such as pipes, heat exchanger tubing, or the like. The interior portion 14 can be defined by at least one wall 18, which can include one or more walls that substantially surround the interior portion 14. One or more openings 12 (shown in FIG. 2) can extend through the at least one wall 18. The shown example includes one opening, however, it is to be understood, that more than one opening can be provided. The opening 12 can provide a passageway from an exterior 16 of the operating device 10 to the interior portion 14 of the operating device 10 through the at least one wall 18. The opening 12 can include a cover (not shown), or a similar covering structure that can selectively open and close the opening 12. As such, when the pulse detonation system 8 is not in association with the operating device 10 and/or access is not needed to the interior portion 14, the opening 12 can be closed by the cover.

Particles 6, such as dust, dirt, ash, accumulated ash, ash piles, soot, slag, or the like, may accumulate on the walls 18 and/or structures (not shown) of the interior portion 14 of the operating device 10. The particles 6 accumulating on the walls and/or structures of the operating device 10 can be difficult to remove. A target area 7 can be defined as an accumulation and/or buildup of one or more particles 6 at a location within the operating device 10, such that the one or more particles 6 form a coating within the operating device 10. The target area 7 is only generically/schematically shown and could be provided at a variety of other locations within the operating device 10. As will be explained below, an example of the pulse detonation system 8 can be used to agitate the particles 6 of the target area 7 by delivering the shock wave 4 into the interior portion 14. The shock wave 4 can engage the particles 6, the walls 18, and/or the structures and cause vibrations within the operating device 10. The shock wave 4 can cause some or all of the walls, structures, and target area 7 to be agitated and/or vibrated such that any accumulated material that forms a coating can be cracked and dislodged. Once agitated, the particles 6 are dislodged from the walls and/or structures within the interior portion 14, and can be more easily removed from the operating device 10.

Referring now to FIG. 2, an example of the pulse detonation system 8 is shown in association with the operating device 10. The pulse detonation system 8 includes the pulse detonation device 20. The pulse detonation device 20 can include a pulse detonation chamber 30 that can create and deliver the shock wave 4.

The pulse detonation chamber 30 is shown to extend through the opening 12 in the operating device 10. The pulse detonation chamber 30 can include an elongated tube-like structure with a hollow center and/or with obstacles inside. The hollow center can define a combustion chamber. The pulse detonation chamber 30 can extend between an inlet end 32 to an outlet end 34. The inlet end 32 can be positioned at the exterior 16 of the operating device 10 while the outlet end 34 can be positioned at the interior portion 14 of the operating device 10. The outlet end 34 can include an opening in the pulse detonation chamber 30, such that the pulse detonation chamber 30 defines a combustion chamber with an open end. The pulse detonation chamber 30 can be of nearly any length, and is not limited to the length in the shown example. For instance, the pulse detonation chamber 30 could be shorter or longer than the pulse detonation chamber 30 as shown.

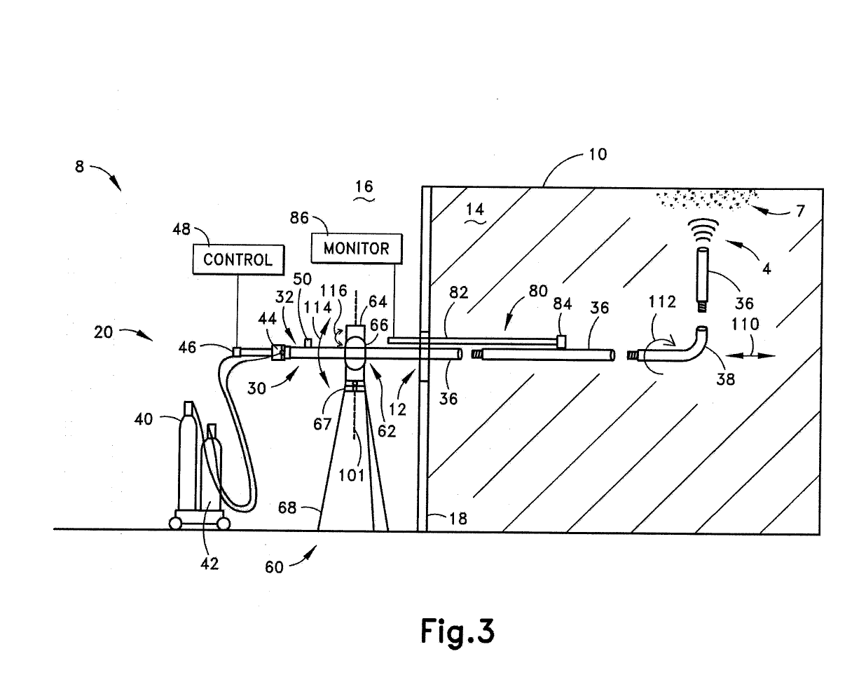

The pulse detonation chamber 30 can include a single elongated tube, or a plurality of tubes attached together to form the pulse detonation chamber 30. For instance, in the shown examples, the pulse detonation chamber 30 can include a plurality of pulse detonation tubes 36 attached in series. The pulse detonation tubes 36 can be attached end to end, such that the pulse detonation tubes 36 extend along a common, elongated, longitudinal axis 100. The pulse detonation tubes 36 can be attached together in a number of different ways. For instance, the pulse detonation tubes 36 can be attached by threading (shown in FIG. 3), such as NPT threading, a quick connect mechanism, welding, or the like. As such, in one example, the pulse detonation tubes 36 can be removably attached to each other, as with the threading or quick connect attachment. Accordingly, the pulse detonation chamber 30 can be removed from the operating device 10 and can be partially or completely disassembled. Disassembly can be accomplished by detaching the pulse detonation tubes 36 from each other, such that the pulse detonation chamber 30 is no longer a single, elongated tube, but, rather, a plurality of pulse detonation tubes 36 that have been detached.

The pulse detonation tube 36 can be formed from a variety of materials, including a high temperature material. The pulse detonation tube 36 can be a double layered jacket, such that cooling air and/or fluid can travel through the jacket to reduce the temperature within the pulse detonation tube 36. Accordingly, the pulse detonation tube 36 can be used at high temperatures with a reduced risk of heat-related problems.

The pulse detonation tubes 36 can include a variety of sizes and lengths. For instance, in one example, each of the pulse detonation tubes 36 can range from approximately 0.91 meters (3 feet) to 1.22 meters (4 feet) in length. In another example, the length of each of the pulse detonation tubes 36 may range from approximately 0.25 meters (10 inches) to 0.51 meters (20 inches). It is to be understood, however, that other length ranges are contemplated. Similarly, the shown examples include three (3) pulse detonation tubes 36 attached in series. However, it is to be understood that more or fewer pulse detonation tubes could be attached. As such, the pulse detonation chamber 30 can be longer or shorter in length, depending on the length of the pulse detonation tubes 36 and/or the number of pulse detonation tubes 36 attached in series. The total length of the pulse detonation chamber 30 can therefore be readily changed and adjusted by a user based on the specific application, size and shape of the operating device 10, etc.

Referring now to FIGS. 2 and 3, the pulse detonation tubes 36 can take on a number of different sizes, shapes, and orientations. For instance, as shown in FIG. 2, the pulse detonation tubes 36 can each have a substantially linear shape, such that each of the pulse detonation tubes 36 extend along a substantially straight axis and form a substantially straight pulse detonation chamber. In another example, as shown in FIG. 3, some or all of the pulse detonation tubes 36 can have a non-linear shape, such that some or all of the pulse detonation tubes 36 have a bend and/or extend along a curve and form a non-linear pulse detonation chamber. In the shown example of FIG. 3, a non-linear pulse detonation tube 38 is provided between two pulse detonation tubes 36 that are substantially linear. The non-linear pulse detonation tube 38 is shown to form a substantially 90° bend. It is to be understood that any shape of bend is contemplated, such as a 45° bend, or any bend between 0° to 180°. In a further example, some or all of the pulse detonation tubes 36 could have multiple bends, such that the pulse detonation tubes 36 can form an S-shaped structure, U-shaped structure, or the like. In yet another example, the pulse detonation chamber 30 could have an adjustable length, such as by adjusting the position of adjacent pulse detonation tubes 36. In this example, one or more of the pulse detonation tubes 36 could include a telescoping section. The telescoping section can adjustably slidably and telescopingly engage an adjacent pulse detonation tube 36, such that one of the pulse detonation tubes 36 can be slidably received within an adjacent pulse detonation tube 36.

Referring to FIG. 2, the pulse detonation device 20 can include a fuel supply 40 and an air supply 42. Fuel and air can be provided from the fuel supply 40 and air supply 42, respectively, to the pulse detonation chamber 30 to create the shock wave 4.

Referring first to the fuel supply 40, the fuel supply 40 can store and/or supply fuel to the pulse detonation chamber 30. The fuel supply 40 can store and supply any number of different fuels, such that the term ‘fuel’ can encompass a variety of fuels. For instance, the fuel supply 40 can include a liquid fuel or a non-liquid fuel, such as a gas. Furthermore, the fuel supply 40 can include ethylene, propane, methane, hydrogen, acetylene, or the like. It is to be understood, however, that the fuel supply 40 is not limited to storing the types of fuels described herein, and could use any further substance that acts as a fuel. Similarly, the fuel supply 40 can include nearly any type of storage structure that is capable of storing fuel. For instance, in the shown example, the fuel supply 40 can include a tank, however, other structures are also contemplated. The fuel supply 40 can take on a number of different sizes, such that different quantities of fuel can be stored and delivered. In the shown example, the fuel tank is relatively small, such that the fuel supply 40 can be portable and relatively easily movable from one location to another by a user. To facilitate moving of the fuel supply 40, a carrying device, such as a cart with wheels, or the like, can be provided to carry fuel supply 40.

The pulse detonation device 20 can further include an oxidizer or air supply 42. The air supply 42 can store and/or supply air to the pulse detonation chamber 30. The air supply 42 can store air or compressed/pressurized air, such as pure oxygen, an oxygen combination, atmospheric oxygen, or the like. It is to be understood, however, that the air supply 42 is not limited to storing the types of air described herein, and could use further substances. Similar to the fuel supply 40, the air supply 42 can include nearly any type of storage structure that is capable of storing air. For instance, in one example, the air supply 42 can include an air tank, however, other structures are also contemplated. The air supply 42 can take on a number of different sizes, such that different quantities of air can be stored. In the shown example, the air tank is relatively small, such that the air supply 42 can be portable and relatively easily moved from one location to another. The air supply 42 can be provided on the carrying device, which could include the cart with wheels.

The pulse detonation chamber 30 can include a fuel inlet 44 and an air inlet 46 through which the pulse detonation chamber 30 can receive fuel and air, respectively. Specifically, the fuel inlet 44 can be in operative association with the fuel supply 40 through a fuel conduit. As such, fuel can be delivered from the fuel supply 40, through the conduit and fuel inlet 44, and into the pulse detonation chamber 30. Similarly, the air inlet 46 can be in operative association with the air supply 42 through an air conduit. As such, air can be delivered from the air supply 42, through the air conduit and air inlet 46, and into the pulse detonation chamber 30. Accordingly, the pulse detonation chamber 30 can simultaneously receive fuel and air through the respective inlets. In further examples, the fuel and air can mix either in the pulse detonation chamber 30, or at a location before reaching the pulse detonation chamber 30. For instance, a single conduit can attached to the fuel supply 40 and air supply 42 at one end, and to an inlet to the pulse detonation chamber 30 at an opposite end. As such, the fuel and air can mix in the single conduit prior to reaching the pulse detonation chamber 30.

The pulse detonation chamber 30 can further include an ignition device 50. The ignition device 50 can provide a spark, charge, or the like to combust and/or ignite the fuel and air mixture. The ignition device 50 can be positioned along a wall near, but in front of, an inlet end 32 of the pulse detonation chamber 30. Accordingly, by positioning the ignition device 50 at a distance from the inlet end 32, the fuel and air can mix prior to flowing past the ignition device 50. The ignition device 50 can include a number of structures known in the art, such as a spark plug, spark discharge, heat source, or the like.

The pulse detonation device 20 can further include a controller 48 that is operably attached to the ignition device 50, fuel inlet 44, and air inlet 46. The controller 48 can operate the ignition device 50, fuel inlet 44 , and air inlet 46 at desired times, such that the inlets can be selectively opened and closed to allow for the passage of fuel and/or air to the pulse detonation chamber 30. Similarly, the controller 48 can control the ignition device 50, such that the ignition device 50 can selectively cause combustion of the fuel and air mixture within the pulse detonation chamber 30. The controller 48 can allow the pulse detonation device 20 to go through one or more sequences, such as cleaning sequences, that allow the pulse detonation device 20 to move and form the shock wave 4. In one example, the controller 48 can include a local trigger, such as a trigger on the device, that can allow a user to operate the pulse detonation device 20 based on one or more pre-programmed parameters. The trigger can allow the user to aim and operate the pulse detonation device 20 at the same time.

The operation of the pulse detonation chamber 30 and the formation of the shock wave 4 can now be described. The controller 48 can selectively trigger the fuel supply 40 and/or air supply 42 to provide fuel and/or air at the inlet end 32 of the pulse detonation chamber 30. The fuel and air can mix either prior to entering the pulse detonation chamber 30, or upon entering the pulse detonation chamber 30 at the inlet end 32. As more fuel and air are introduced and mixed, the pulse detonation chamber 30 can fill with the fuel/air mixture, starting at the inlet end 32 and progressing along the pulse detonation chamber 30 towards the inlet end 32. The controller 48 can track the amount of fuel/air mixture in the tube and can close a valve to stop the flow of the fuel and/or air into the pulse detonation chamber 30 after an amount of time has passed. The ignition device 50 can be triggered by the controller 48 to initiate the combustion of the fuel/air mixture by providing a spark, or other ignition source, to the pulse detonation chamber 30. The spark can create a flame within the fuel/air mixture near the ignition device 50. The flame can consume the fuel/air mixture by burning it and, as such, a shock wave front will propagate and accelerate through the fuel/air mixture within the pulse detonation chamber 30 in such a way to create the shock wave 4.

The shock wave front propagating through the pulse detonation chamber 30 creates a relatively high temperature and pressure environment to produce the shock wave 4. Pressure can increase behind the shock wave 4 to drive the shock wave away from the inlet end 32 of the pulse detonation chamber 30. The shock wave 4 travels down the length of the pulse detonation chamber 30 and can travel at high speeds, such as from Mach 2 to Mach 5. Similarly, the pressure immediately behind the shock wave 4 can also be high, such as 18 to 30 times the initial pressure. For instance, if the shock wave 4 is traveling through an atmospheric pressure vessel, the pressure immediately behind the shock wave 4 could be 18-30 times atmospheric pressure. The temperature immediately behind the shock wave 4 can also be relatively high. When the shock wave 4 exits the pulse detonation chamber 30, high-pressure by-products of the combustion can escape through the same inlet end 32.

As used herein, the pulse detonation device 20 can refer to a device and/or system that produces either or both a pressure rise and a velocity increase from the detonation or quasi-detonation of a fuel and oxidizer. The pulse detonation device 20 can be operated in a repeating mode to produce multiple detonations or quasi-detonations within the device. A detonation is a supersonic combustion in which a shock wave is coupled to a combustion zone, and the shock is sustained by the energy release from the combustion zone, resulting in combustion products at a higher pressure than the combustion reactants. For simplicity, the term “detonation” can include both detonations and quasi-detonations. A quasi-detonation can include a supersonic turbulent combustion process that produces a pressure rise and velocity increase higher than a pressure rise and velocity increase produced by a sub-sonic deflagration wave.

It is to be understood that the pulse detonation device 20 and the pulse detonation chamber 30 shown and described herein is only generically/schematically shown and may be varied in construction and function. As such, the pulse detonation chamber 30 shown in the examples is not intended to be a limitation on the present invention. Instead, the pulse detonation chamber can include a variety of pulse detonation chambers and devices that are known in the art. For instance, in one example, the pulse detonation chamber 30 could include multiple deflecting surfaces causing the shock wave to deflect in multiple directions before exiting the pulse detonation chamber. In further examples, an expanding cross-section area horn may be provided. However, for focus and clarity, the horn is not shown in the examples.

Referring still to FIG. 2, the pulse detonation device 20 can further include a support structure 60 that supports the pulse detonation chamber 30. The support structure 60 can include a supporting device 68 and an attachment device 62. The attachment device 62 can be attached to the pulse detonation chamber 30 while the supporting device 68 can support both the attachment device 62 and pulse detonation chamber 30.

The attachment device 62 can be positioned at the exterior 16 of the operating device 10 near the opening 12. The attachment device 62 can comprise an outer housing 64 and a bearing 66 positioned within the outer housing. The outer housing 64 is shown as a solid material having an opening extending completely through a portion of the outer housing 64. In the shown example, the opening extends through a center of the outer housing 64, though other locations of the opening are contemplated. The opening can take on a number of shapes, including, but not limited to square, circular, oval, or the like. Similarly, the opening can be larger in diameter than a diameter of the pulse detonation chamber 30.

The attachment device 62 further includes the bearing 66. The bearing 66 can be positioned within the opening of the outer housing 64, such that the outer housing 64 can hold and/or receive the bearing 66. The bearing 66 can take on a number of shapes, though in the shown example, the bearing 66 is sized and shaped to match the size and shape of the opening in the outer housing 64. Specifically, an outer diameter of the bearing 66 can be slightly smaller than a diameter of the opening in the outer housing 64, such that the bearing 66 can be non-movably received by the outer housing 64. The bearing 66 and/or the outer housing 64 could further include attachment devices (not shown) that function to attach the bearing 66 inside the outer housing 64. The attachment devices could include adhesives, snap fit means, a nut and bolt assembly, etc. In a further example, the bearing 66 could be removably attached to the outer housing 64, such that the bearing 66 can be inserted into the outer housing 64, and removed from the outer housing 64.

The bearing 66 can include a number of structures that function to allow movement. For instance, the bearing 66 can provide for rotation about the longitudinal axis 100, for pivoting angular movement, such as by including a spherical bearing. In such an example, the spherical bearing could provide for up/down pivoting movement, such as along a substantially vertical axis, and/or side to side pivoting movement, such as along a substantially horizontal axis, or even 360° pivoting movement. As such, the bearing 66 could include nearly any type of spherical bearing that allows for longitudinal movement along longitudinal axis 100, pivoting angular movement, and axial rotation.

The attachment between the bearing 66 and the pulse detonation chamber 30 can now be described. The bearing 66 can include a central opening that is sized and shaped to receive the pulse detonation chamber 30. The central opening of the bearing 66 can be sized slightly larger in diameter than an outer diameter of the pulse detonation chamber 30. As such, the pulse detonation chamber 30 can be received and held within the bearing 66. In further examples, attachment structures (not shown), such as nuts and bolts, threaded screws, or the like can assist in attaching the pulse detonation chamber 30 to the bearing 66. Specifically, the attachment structures can engage both the bearing 66 and pulse detonation chamber 30 to hold them in attachment. It is further contemplated that the pulse detonation chamber 30 and bearing 66 can be removably attached to each other, such that the pulse detonation chamber 30 can be removed from the bearing 66. In such an example, the attachment structures could be removed, loosened, or the like, such that the pulse detonation chamber 30 can be removed from the bearing 66.

In further examples, the pulse detonation chamber 30 can be movable with respect to the bearing 66. For instance, the pulse detonation chamber 30 can be movable in a first direction 110 that is parallel to the longitudinal axis 100. Specifically, the pulse detonation chamber 30 can be movable in a forward direction and a backward direction along the longitudinal axis 100. As such, when the pulse detonation chamber 30 is moved forwards, the pulse detonation chamber 30 can move further into the interior portion 14 of the operating device 10. Similarly, when the pulse detonation chamber 30 is moved backwards, the pulse detonation chamber 30 moves out of the operating device 10. Therefore, movement of the pulse detonation chamber 30 along the first direction 110 either forwards or backwards can adjust the positioning of the outlet end 34 within the interior portion 14 of the operating device 10. A user can point the outlet end 34 at varying positions within the interior portion 14, thus controlling the location where the shock wave 4 engages the interior portion 14, thereby creating a larger coverage area within the interior portion 14 of the operating device 10.

As described above, the bearing 66, which may include a spherical bearing, or the like, can allow the pulse detonation chamber 30 to rotate. As such, the pulse detonation chamber 30 can axially rotate about the longitudinal axis 100 in a second direction 112. In such an example, the pulse detonation chamber 30 can rotate in a clockwise or counterclockwise direction. Attachment devices (not shown) can limit axial rotation of the pulse detonation chamber 30, such that a user can rotate the pulse detonation chamber 30 to a desired position, and lock the pulse detonation chamber in place with one or more attachment devices. Accordingly, the pulse detonation chamber can remain in the desired position without further, unintended rotation. Axial rotation in the second direction 112 can allow the user to point the outlet end 34 at varying positions within the interior portion 14. Specifically, when the pulse detonation chamber 30 extends along a non-linear axis, such as by including one or more bends (shown in FIG. 3), the outlet end 34 of the pulse detonation chamber 30 can be adjusted to point at varying positions within the interior portion 14. The location of where the shock wave 4 engages the interior portion 14 can thus be controlled, thereby creating a larger coverage area within the interior portion 14 of the operating device 10.

The support structure 60 can further include the supporting device 68 that supports the attachment device 62. The supporting device 68 can include a number of different structures that provide support to the attachment device 62. Moreover, the supporting device 68 can be formed from a sufficiently strong material to support the attachment device 62 and pulse detonation chamber 30. The support structure 60 can include a tripod, a frame, a base, a cart, or the like. It is to be understood that the support structure 60 is only generically/schematically shown and may be varied in construction and function. As such, the support structure 60 shown in the examples is not intended to be a limitation on the present invention, and nearly any type of structure that can support the attachment device 62 is envisioned and pulse detonation chamber 30 is envisioned.

The attachment device 62 can be movably attached to the support structure 60. For instance, the support structure 60 could include a movement structure 67 that allows the attachment device 62 to move with respect to the support structure 60. In this example, the movement structure 67 can include a horizontal bore extending along a horizontal axis and a vertical bore extending along a vertical axis. The attachment device 62 could be attached to the horizontal bore, such that the attachment device 62 can pivot upwards and downwards along a third direction 114. Movement along the third direction 114 can allow the outlet end 34 of the pulse detonation chamber 30 to move upwards and downwards within the interior portion 14. As such, the user can point the outlet end 34 at varying up and down positions within the interior portion 14 extending along a vertical axis. By controlling the up and down position of the inlet end 32, the shock waves can engage the interior portion 14 along a larger coverage area within the operating device 10.

The movement structure 67 can further include the vertical bore (not shown) extending along the vertical axis. The attachment device 62 can be attached with respect to the vertical bore, such that the attachment device 62 can pivot about a vertical axis 101 along a fourth direction 116. Movement along the fourth direction 116 can allow the pulse detonation chamber 30 to move side-to-side, such as along a horizontal plane. Side-to-side movement can allow the outlet end 34 of the pulse detonation chamber 30 to move side-to-side within the interior portion 14. By controlling the side-to-side position of the inlet end 32, the shock waves can engage the interior portion 14 along a larger coverage area within the operating device 10.

The supporting device 68 can be removably attached to the attachment device 62. As such, the user can attach and detach the supporting device 68 to the attachment device 62. The supporting device 68 and attachment device 62 can be attached in a number of ways, using any number of attachment structures. For instance, a nut and bolt assembly, snap fit means, or the like can be used to attach the supporting device 68 to the attachment device 62.

Referring still to FIG. 2, the pulse detonation system 8 can further include a camera apparatus 80. The camera apparatus 80 can capture images and/or video the interior portion 14 of the operating device 10. The camera apparatus can deliver the images/video from the interior portion 14 to the exterior 16, whereupon the images/video can be displayed on a monitor 86.

The camera apparatus 80 can include a sleeve portion 82. The sleeve portion 82 can include an elongated, substantially hollow tube that extends along a longitudinal axis. The sleeve portion 82 can extend through the opening 12 in the at least one wall 18 of the operating device 10 such that the sleeve portion 82 can extend from the exterior 16 at one end to the interior portion 14 of the operating device 10 at an opposite end. The sleeve portion 82 can be mounted, such as to a mounting structure (not shown) or to the pulse detonation device 20. In further examples, the sleeve portion 82 may not be mounted, and instead can be held by a user, such that the user can manually move the sleeve portion 82. The sleeve portion 82 can be formed from a variety of materials, including a high temperature material. The sleeve portion 82 can be substantially rigid, or can be flexible, thus allowing a user to manipulate and/or bend the sleeve portion 82. In further examples, the sleeve portion 82 could include a double layered jacket, such that cooling air and/or fluid can travel through the jacket to reduce the temperature within the sleeve portion 82. Accordingly, the sleeve portion 82 can safely house electrical equipment, such as wires, or the like, at high temperatures with a reduced risk of heat-related problems.

The camera apparatus 80 can further include a camera head 84. The camera head 84 can be attached to an end of the sleeve portion 82, and can be positioned to extend within the interior portion 14 of the operating device 10. The camera head 84 can include nearly any type of visual recording device that captures images and/or video. For instance, the camera head 84 could include a high-temperature camera that can effectively operate at the temperatures within the operating device 10. Further, the camera head 84 could include a housing, protection device, or the like that can partially or completely surround the camera to provide protection. A lighting apparatus (not shown) can be provided with the camera head 84 to illuminate the interior portion 14.

The camera head 84 can be operatively attached to wires, cables, bundles, or the like that extend from the exterior 16 to the interior portion 14. The wires can be in association with the camera head 84, such that the power, data, images, video, or the like can be transmitted to/from the camera head 84. The wires can extend from the camera head 84 at one end to a monitor 86 at an opposing end. The monitor 86 can receive and display the images/video that are captured by the camera head 84. The monitor 86 can include nearly any type of visual display unit. The monitor 86 could include a smaller screen that is portable, allowing a user to easily carry the monitor 86 and camera apparatus 80 from one location to another. The monitor 86 can be positioned at the exterior 16 of the operating device 10, such that the monitor 86 will not be subject to the same high temperatures as the camera head 84.

The operation of the camera apparatus 80 can now be briefly described. A user can hold the end of the sleeve portion 82 at the exterior 16 of the operating device 10 adjacent the opening 12. The sleeve portion 82 can extend through the opening and into the interior portion 14 of the operating device 10, such that the camera head 84 is positioned within the interior portion 14. The camera head 84 can capture video and/or images of the interior portion 14. The camera head 84 can transmit this video to the monitor 86, such that the monitor 86 can display a real-time video/image of the interior portion 14. The user can simultaneously view the monitor 86 while holding and manipulating the sleeve portion 82. Thus, the user can view the monitor 86 to search for one or more target areas 7 within the operating device 10. The user can move the camera head 84 within the interior portion 14 to view a relatively large area of walls, structures, or the like within the operating device 10.

The operation of the pulse detonation system 8 can now be described. Initially, a user can assemble the pulse detonation device 20 from a disassembled state. For instance, one or more of the pulse detonation tubes 36 can be attached in series. The pulse detonation tubes 36 can be attached together in a number of ways, such as by a threading engagement, or the like. Once attached, the pulse detonation tubes 36 will together form the pulse detonation chamber 30. The pulse detonation chamber 30 can then be attached to the attachment device 62. Specifically, the pulse detonation chamber 30 can be inserted through a central opening in the bearing 66. In one example, attachment structures, such as screws, adhesives, or the like, can be provided to attach the pulse detonation chamber 30 in place with respect to the bearing 66. The attachment device 62 can then be attached to the supporting device 68. The supporting device 68 can be positioned near the opening 12 of the operating device 10. As discussed, the pulse detonation chamber 30 can be positioned to extend through the opening and into the interior portion 14.

Once the pulse detonation system 8 has been assembled, a user can use the camera apparatus 80 to search for target areas 7, which can include a buildup of particles 6 within the operating device 10. The user can hold the sleeve portion 82 such that the sleeve portion 82 extends through the opening 12 with the camera head 84 positioned inside the operating device 10. The camera head 84 can capture images/video within the operating device 10, and display the images/video on the monitor 86. Once the user sees a buildup of particles within the operating device 10 on the monitor 86, the user can orient the pulse detonation chamber 30 towards this target area 7.

The pulse detonation chamber 30 can be positioned such that the outlet end 34 can aim at a variety of locations within the operating device 10. Specifically, the pulse detonation chamber 30 can be movable along a plurality of directions 110, 112, 114, 116. For instance, the pulse detonation chamber 30 can be moved forwards and backwards with respect to the bearing 66 in the first direction 110. The pulse detonation chamber 30 could also be rotated by the bearing 66, such that pulse detonation chamber 30 is axially rotatable about the longitudinal axis 100 in the second direction 112. Similarly, the attachment device 62 can be moved with respect to the movement structure 67, such that the pulse detonation chamber 30 can pivot in the third direction 114 that is upwards and downwards. Lastly, the attachment device 62 can be pivoted in the fourth direction 116 with respect to the movement structure 67, such that the pulse detonation chamber 30 can pivot in a side-to-side direction. Therefore, the user can orient the outlet end 34 at multiple positions within the operating device 10 based on the images/video on the monitor 86.

Once the pulse detonation chamber 30 is aimed at the target area, the user can initiate the combustion of fuel and air to produce the shock wave 4. The user can initiate the controller 48 to provide fuel and air from the fuel supply 40 and air supply 42, respectively. The fuel and air can mix either prior to entering the pulse detonation chamber 30, or upon entering the pulse detonation chamber 30 at the inlet end 32. As more fuel and air are introduced and mixed in the pulse detonation chamber 30, the pulse detonation chamber 30 can fill with the fuel/air mixture, starting at the inlet end 32 and progressing towards the outlet end 34. The controller 48 can track the amount of fuel/air mixture in the tube and can close a valve to stop the flow of fuel and/or air from the fuel supply 40 and air supply 42.

The ignition device 50 can be triggered by the controller 48 to initiate the combustion of the fuel/air mixture by providing a spark to the pulse detonation chamber 30. The spark can create a flame within the fuel/air mixture near the ignition device 50. The flame can consume the fuel/air mixture within the pulse detonation chamber 30 towards the inlet end 32. The shock wave front propagating through the pulse detonation chamber 30 creates a relatively high temperature and pressure environment to produce a detonation wave, or a shock wave 4. Pressure can increase behind the shock wave 4 to drive the shock wave 4 towards the inlet end 32. The shock wave 4 travels down the length of the pulse detonation chamber 30 and out of the inlet end 32. Upon leaving the pulse detonation chamber 30, the shock wave 4 can be traveling at relatively high speeds. Similarly, the pressure immediately generated by the shock wave 4 can also be relatively high. The temperature of the shock wave 4 can also be relatively high and can include a high temperature reaction zone.

Upon exiting the outlet end 34 of the pulse detonation chamber 30, the shock wave 4 can enter the interior portion 14 of the operating device 10 and engage particles 6, walls 18, and/or structures. Moreover, since the outlet end 34 is oriented towards the target area 7 of particles 6, the shock wave can also engage the target area 7. Specifically, the shock wave can cause vibration in the particles 6, target area 7, walls 18, and/or structures. This vibration can cause the particles 6 to be loosened and/or dislodged from the walls 18 or structures. Once the particles 6 are loosened and/or dislodged, the particles 6 can be more easily removed from the operating device 10, thus reducing the total number of target areas 7 and minimizing the downtime of the operating device 10.

The pulse detonation device 20 can be portable, such that the pulse detonation device 20 can be selectively disassembled and reassembled, allowing the pulse detonation device 20 to be moved from one location to another. By being portable, the pulse detonation device 20 can be readily disassembled, with the pulse detonation tubes 36 being detachable from each other. Similarly, the pulse detonation tubes 36 can be detached from the attachment device 62 of the support structure 60. The attachment device 62 can also selectively be detached from the supporting device 68. As such, the pulse detonation device 20 can be moved from location to location as a disassembled unit, with the pulse detonation tubes 36 disassembled from the attachment device 62, and the attachment device 62 disassembled from the support structure 60. Accordingly, a user can move the disassembled pulse detonation device to a second location, such as a second operating device, and reassemble the pulse detonation device 20 to extend into the second operating device.

In a further example, the pulse detonation device 20 is portable and can be carried, such that the support structure 60 may not be used. In such an example, the pulse detonation tubes 36 can be attached to each other, but can be detached from the support structure 60. Accordingly, the pulse detonation chamber 30 is portable and can be carried by a user from one location to another, with the pulse detonation tubes 36 attached in series. The user can hold the pulse detonation chamber 30 near an operating device 10, such that the pulse detonation chamber 30 can extend into the operating device 10. In this example, the user can selectively move the pulse detonation chamber 30 between various operating devices without using the support structure 60.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A pulse detonation system for providing a cleaning shock wave to an interior surface of an operating device, the pulse detonation system comprising:
a pulse detonation chamber configured to provide one or more shock waves into the operating device, wherein the pulse detonation chamber includes at least one pulse detonation tube;
wherein the pulse detonation chamber is configured to be movable with respect to the operating device, further wherein an outlet end of the pulse detonation chamber is configured to be oriented towards a plurality of locations within the operating device.

2. The pulse detonation system of claim 1, wherein the at least one pulse detonation tube includes a plurality of pulse detonation tubes attached in series, further wherein each of the pulse detonation tubes is removably attached to a second pulse detonation tube.

3. The pulse detonation system of claim 2, wherein one of the plurality of pulse detonation tubes extends along a non-linear axis.

4. The pulse detonation system of claim 3, wherein the one of the plurality of pulse detonation tubes extending along a non-linear axis forms a 90° bend.

5. The pulse detonation system of claim 1, further including a camera apparatus extending from the exterior to an interior portion of the operating device, the camera apparatus being configured to capture images of the interior portion of the operating device.

6. The pulse detonation system of claim 5, wherein the camera apparatus further includes a monitor.

7. The pulse detonation system of claim 6, wherein the camera apparatus is configured to transmit and display images of the interior portion of the operating device to the monitor.

8. The pulse detonation system of claim 1, further including a support structure positioned external to the operating device and configured to support the pulse detonation chamber, wherein the support structure further includes a bearing such that the pulse detonation chamber is attached to the bearing.

9. The pulse detonation system of claim 8, wherein the bearing is configured to provide rotational movement such that the pulse detonation chamber is rotatable about a longitudinal axis coaxial with the pulse detonation chamber.

10. The pulse detonation system of claim 8, wherein the bearing comprises a spherical bearing configured to provide angular movement, further wherein the pulse detonation chamber is movable along a horizontal axis and a vertical axis.

11. A portable pulse detonation system for providing a shock wave to an operating device, the portable pulse detonation system comprising:
a camera apparatus configured to capture and display images of an interior portion of the operating device; and
a pulse detonation chamber extending from an exterior to the interior portion of the operating device, the pulse detonation chamber configured to provide one or more shock waves to the interior portion of the operating device, wherein the pulse detonation chamber includes at least one pulse detonation tube removably attached to a second pulse detonation tube.

12. The portable pulse detonation system of claim 10, further including a support structure positioned at the exterior of the operating device, wherein the pulse detonation chamber is removably attached to the support structure.

13. The portable pulse detonation system of claim 12, wherein the pulse detonation chamber is movable with respect to the support structure in a direction that is coaxial with a longitudinal axis of the pulse detonation chamber.

14. The portable pulse detonation system of claim 12, wherein the pulse detonation chamber is pivotable with respect to the support structure and is configured to rotate about the longitudinal axis.

15. The portable pulse detonation system of claim 12, wherein the support structure is configured to provide for angular rotation of the pulse detonation chamber with respect to the support structure.

16. The portable pulse detonation system of claim 12, wherein the pulse detonation chamber is movable along a substantially vertical axis and a substantially horizontal axis with respect to the support structure.

17. A method of cleaning an operating device, the method including:
displaying images of an interior portion of the operating device with a camera apparatus;
positioning a pulse detonation chamber to extend from an exterior to the interior portion of the operating device;
orienting the pulse detonation chamber towards a target area based on the images of from the camera apparatus; and
igniting a mixture of fuel and air in the pulse detonation chamber to create a shock wave, wherein the shock wave exits the pulse detonation chamber and engages the target area of the operating device.

18. The method of claim 17, further comprising the step of removing the pulse detonation chamber from extending into the interior portion of the operating device and moving the pulse detonation chamber to a second location outside of the operating device.

19. The method of claim 17, further comprising the step of providing a support structure positioned at the exterior of the operating device for attachment to the pulse detonation chamber and moving the pulse detonation chamber with respect to the support structure towards the target area.

20. The method of claim 19, further comprising the step of detaching the pulse detonation chamber from the support structure and moving the pulse detonation chamber to a second location outside of the operating device.
